(19) United States
(12) Patent Application Publication
(10) Pub. No.: US 2016/0347575 A1
(43) Pub. Date: Dec. 1, 2016

(54) WINDER AND ELECTRONIC DEVICE WITH WINDER

(71) Applicant: HON HAI PRECISION INDUSTRY CO., LTD., New Taipei (TW)

(72) Inventors: CHEN-CHING CHU, New Taipei (TW); CHENG-KUO LEE, New Taipei (TW); YU-NING WANG, New Taipei (TW)

(21) Appl. No.: 14/819,638

(22) Filed: Aug. 6, 2015

(30) Foreign Application Priority Data
May 29, 2015 (CN) 201510285590.1

(51) Int. Cl. B65H 75/44; H02G 11/02; B65H 75/48

(52) U.S. Cl. CPC B65H 75/4442; B65H 75/486; H02G 11/02; B65H 2701/34

(57) ABSTRACT

A winder includes a case including a base, a winding device positioned on the base for winding or releasing the wire, a braking device located between the winding device and the base, and a loading board positioned on the winding device. The braking device includes a ratchet and a pawl positioned aside the ratchet. The winding device, the ratchet and the loading board can rotate together relative to the base. When the pawl is coupled to the ratchet, rotation of the winding device drives the ratchet and the loading board to rotate along a first direction, for releasing the wire from the winding device. When the pawl is detached from the ratchet, the winding device rotates along a second direction counter to the first direction and drives the ratchet and the loading board to rotate along the second direction, for winding the wire to the winding device.

### FIELD

The subject matter herein generally relates to wire tidying apparatuses, particularly relates to a winder for wire and an electronic device with the winder.

### BACKGROUND

Wires are wildly used in many fields, for example, most electronic devices generally use cables or transmission line wires or other wires for data communication.

### BRIEF DESCRIPTION OF THE DRAWINGS

Implementations of the present technology will now be described, by way of example only, with reference to the attached figures.

FIG. 1 is an isometric, assembled view of a winder in accordance with an embodiment of the present disclosure.

FIG. 2 is an isometric, exploded view of the winder of FIG. 1.

FIG. 3 is an isometric, exploded view of the winder of FIG. 2.

FIG. 4 is an isometric, assembled view of an electronic device in accordance with an embodiment of the present disclosure.

FIG. 5 is an isometric, exploded view of the electronic device of FIG. 4.

FIG. 6 is an isometric, exploded view of the electronic device of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a winder for wire. The winder can include a case including a base, a winding device positioned on the base for winding the wire or releasing the wire, a braking device located between the winding device and the base, and a loading board positioned on the winding device and configured to electrically coupling the wire. The braking device includes a ratchet and a pawl positioned aside the ratchet for coupling the ratchet. The winding device, the ratchet and the loading board can rotate together relative to the base. When the pawl is coupled to the ratchet, rotation of the winding device drives the ratchet and the loading board to rotate along a first direction, for releasing the wire from the winding device. When the pawl is detached from the ratchet, the winding device rotates along a second direction counter to the first direction and drives the ratchet and the loading board to rotate along the second direction, for winding the wire to the winding device.

The present disclosure is described further in relation to an electronic device with a winder. The electronic device can include a wire including a fixing portion and a winding portion spaced from the fixing portion and a winder configured to wind or release the winding portion of the wire. The wire has a plurality of signal lines extending through the fixing portion and the winding portion. The winder can include a loading board including a plurality of electrode collars electrically insulating to each other, a winding device coupled to the loading board for winding the wire or releasing the wire, and a braking device coupled to the winding device. The braking device includes a ratchet and a pawl positioned aside the ratchet for coupling the ratchet. The signal lines of the fixing portion are electrically coupled to the electrode collars respectively. The winding portion has a first end attached to the winding device, the signal lines of the first end of the winding portion are electrically coupled to the electrode collars respectively. The signal lines of the fixing portion and the winding portion form complete signal channels via the electrode collars. The winding device, the ratchet and the loading board can rotate together. When the pawl is coupled to the ratchet, rotation of the winding device drives the ratchet and the loading board to rotate along a first direction and releases the winding portion of the wire from the winding device. When the pawl is detached from the ratchet, the winding device rotates along a second direction counter to the first direction, drives the ratchet and the loading board to rotate along the second direction, and winds the winding portion of the wire to the winding device.

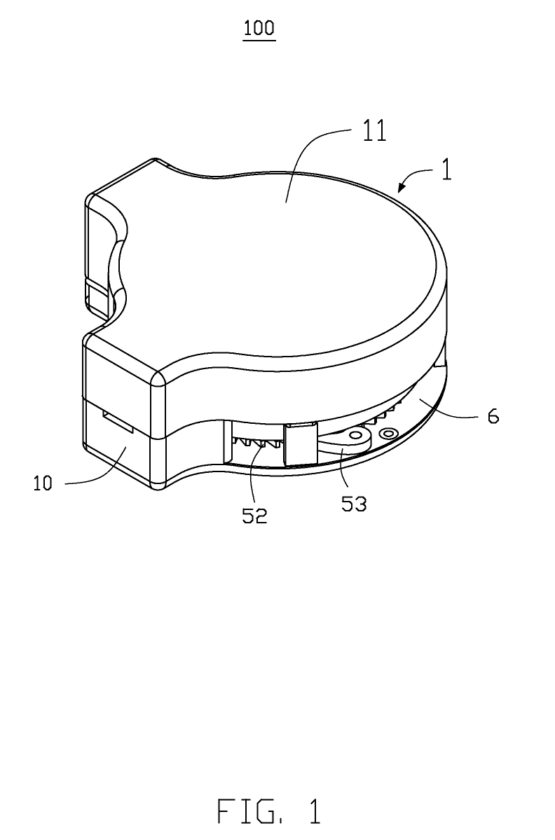

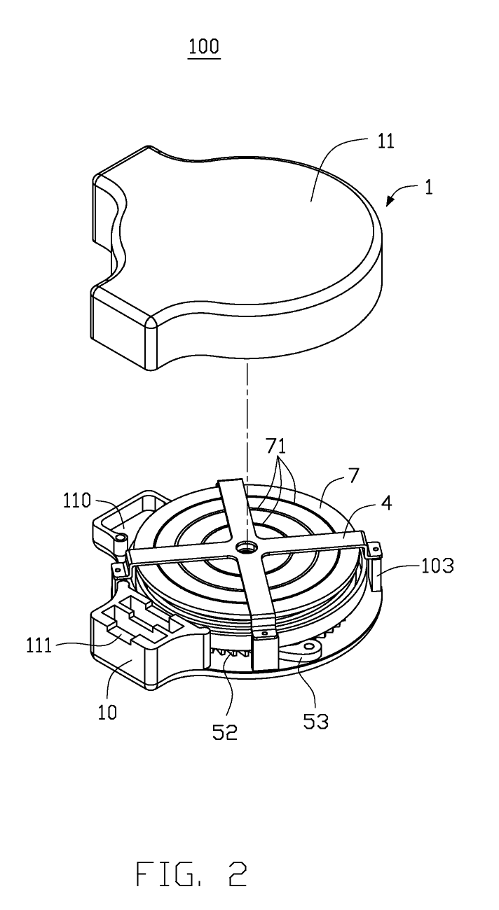

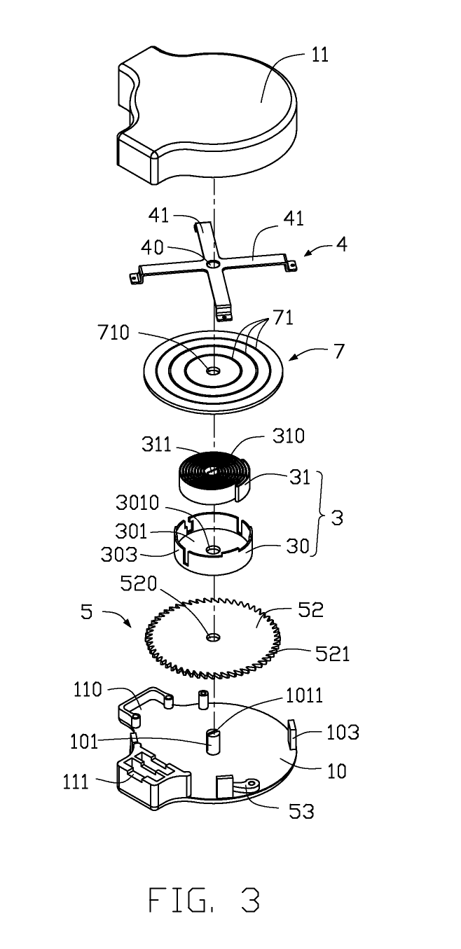

FIGS. 1-3 illustrate a winder 100 of an embodiment of the present disclosure. The winder 100 is used for winding wires such as wires of earphones, cables or transmission line wires of other electronic devices, or other wires. The winder 100 can include a case 1, a winding device 3 in the case 1, a fixing device 4 coupled to the case 1, and a braking device 5 coupled to the case 1.

The case 1 can include a base 10 and a cover 11 covering on the base 10. The base 10 and the cover 11 cooperatively define a hollow room for receiving the winding device 3, the fixing device 4 and the braking device 5 therein. The base 10 extends two flanges toward the cover 11. The two flanges define a first window 110 and a second window 111 respectively for the wires entering into or exiting out of the case 1. In at least an embodiment, the first window 110 and the second window 111 each can be cooperatively defined by the base 10 and the cover 11. The first widow 110 and the second window 111 are located between the base 10 and the cover 11. The base 10 extends a rod 101 from a center thereof toward the cover 11 for coupling the winding device 3 and the braking device 5. The rod 101 defines a slot 1011 through a center thereof. The base 10 further extends a plurality of legs 103 for support the cover 11.

The winding device 3 can include a winding frame 30 and a coil spring 31 received in the winding frame 30. The winding frame 30 can include a bottom 301 and a sidewall 303 extending from the bottom 301. The bottom 301 and the sidewall 303 cooperatively define a hollow room receiving the coil spring 30 therein. The sidewall 303 is in a shape of a cylinder. The bottom 301 of the winding frame 31 defines a through hole 3010 for receiving the rod 101. In this embodiment, the coil spring 31 is coupled to the winding frame 30 and can rotate with the winding frame 30. The coil spring 31 defines a channel 310 in a center thereof. The coil spring 31 can include a coupling beam 311 in the channel 310.

The fixing device 4 is configured to fix a portion of the wire. The fixing device 4 can define a through aperture 40 in a central portion thereof. The fixing device 4 can include a plurality of brackets 41 extending from the central portion thereof. In at least an embodiment, the number of the brackets 41 can be four. The four brackets 41 are spaced from each other. The four brackets 41 are evenly extending from a periphery of the central portion of the fixing device 4.

The braking device 5 can include a ratchet 52 and a pawl 53 for coupling the ratchet 52. The ratchet 52 defines a central hole 520 for coupling the rod 101. The ratchet 52 is a wheel or bar with sloping teeth 521, which can move only in one direction, when the pawl 53 is coupled to the teeth 521, the ratchet 52 stops from moving backward.

In an assembly of the case 1, the rotating device 5 is positioned on the base 10 of the case 1, with the rod 101 extending though the central hole 520 of the ratchet 52, the pawl 53 is positioned on the base 10 at a side of the ratchet 52. The pawl 53 is transitionable between a first configuration in which the pawl 53 is located between two sloping teeth 521 of the ratchet 52 to couple to the ratchet 52, and a second configuration in which the pawl 53 is remote from the ratchet 52 to detach from the ratchet 52. The winding device 3 is positioned on the ratchet 52. The rod 101 is received in the through hole 3010 of the winding frame 30 and the channel 310 of the coil spring 31, the coupling beam 311 is received in the slot 1011 of the rod 101. The fixing device 4 is positioned on the winding device 3 and has a distal end of the rod 101 received in the through aperture 40. The brackets 41 of the fixing device 4 have distal ends thereof fixed to the legs 103 of the base 10 of the case 1. The cover 11 of the case 1 is positioned on the base 10 and covers the winding device 3, the fixing device 4 and the rotating device 5 on the base 10. The legs 103 support the cover 11 on the base 10. The first window 110 and the second window 111 are located between the flanges of the base 10 and the cover 11. An opening 6 is defined between the base 10 and the cover 11, the pawl 53 is exposed outwards via the opening 6. In at least an embodiment, the pawl 53 can couple with a pressing button located outside the opening 6. In at least an embodiment, the rod 101 is interferentialy received in the winding frame 30, the coli spring 31 and ratchet 52. The winding frame 30, the coli spring 31 and ratchet 52 can rotate together with a rotation of the rod 101.

In use, when winding the wire, the wire has one end attached to the winding frame 30 via the first window 110 or the second window 111, the pawl 53 is moved away to detach from the two sloping teeth 521 of the ratchet 52, the coil spring 31 provides elastic restoring force to the rod 101, rod 101 rotates and drives the winding frame 30 and the ratchet 52 to rotate along a first direction, the wire is winded on the sidewall 303 of the winding frame 30. When pulling the wire from the winder 100, the wire pulls the winding frame 30 to rotate, the ratchet 52 rotate together with the winding frame 30 via the rod 101 along a second direction counter to the first direction. When stopping pulling the wire, the pawl 53 is coupled between the two sloping teeth 521 of the ratchet 52, the ratchet 52 stop rotation, the winding frame 30 stop rotation via the rod 10, therefore, the wire is fixed at a required length.

In at least an embodiment, the winder 100 further include a loading board 7 positioned between the winding device 3 and the fixing device 4, for electric loading a wire which is needed winded by the winder 100. The loading board 7 can be a printed circuit board. The loading board 7 defines a central aperture 70 receiving the rod 101 therein. The loading board 7 can include a plurality of electrode collars 71. The electrode collars 71 are concentric and surrounding the central aperture 70 one by one along a radial direction. The electrode collars 71 are electrically insulating to each other. The loading board 7 is electrically insulating to the winding device 3 and the fixing device 4.

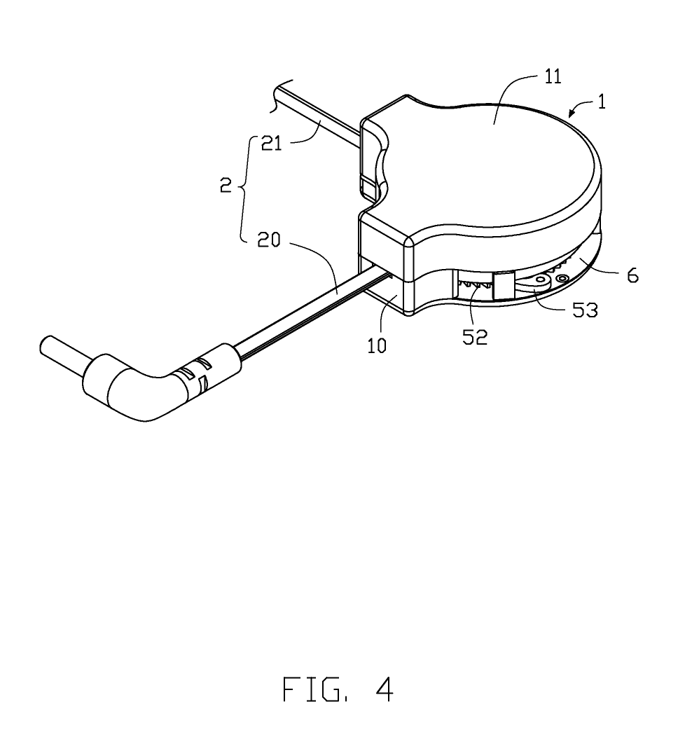

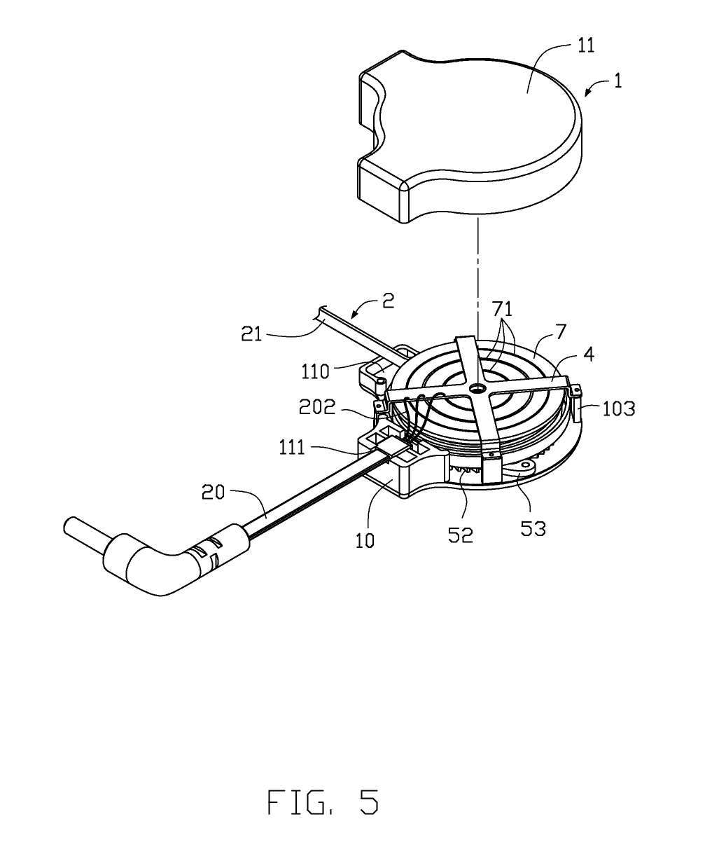

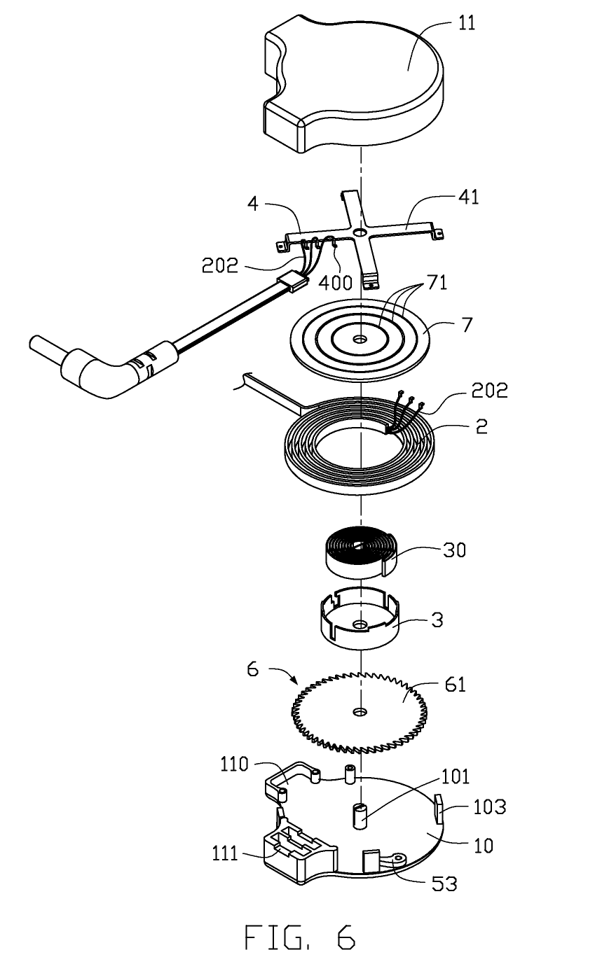

Referring to FIGS. 4-6, an electronic device using the winder 100 is illustrated. The electronic device can include a wire 2 and the winder 100 coupled to the wire 2. The wire 2 can be a wire of earphone, a cables or transmission line wire, in this embodiment, the wire 2 is illustrated with the wire of earphone.

The wire 2 includes a fixing portion 20 and a winding portion 21 spaced from and coupled to fixing portion 20 via the loading board 7 of the winder 100. The wire 2 has a plurality of signal lines 202 extending through the fixing portion 20 and the winding portion 21. The fixing portion 20 extends through the second window 111, and has a first end located in the case 1 and a second end exposed out of the case 1. The winding portion 21 has a first end attached to the winding frame 30 of the wider 100, and a second end exposed out of the case 1 via the first window 110 of the case 1. The signal lines 202 of the first end of the fixing portion 20 are coupled to one of the bracket 41 and each have a contacting tab 400 at a distal end thereof. The plurality of contacting pads 400 electrically contact first faces of the plurality of the electrode collars 71 of the loading board 7, respectively. The signal lines 202 of the first end of the winding portion 21 electrically contact second faces of the plurality of the electrode collars 71 respectively. The first faces of the electrode collars 71 are opposite to the second faces of the electrode collars 71. The signal lines 202 of the fixing portion 20 and the winding portion 21 form complete and right signal channels via the electrode collars 71 of the loading board 7.

In use, when winding the wire 2, the pawl 53 of the braking device 50 of the winder 100 is moved away to detach from the two sloping teeth 521 of the ratchet 52 of the braking device 50, the coil spring 31 of the winding device 3 provides elastic restoring force to the rod 101 of the winder 100, the rod 101 rotates and drives the winding frame 30 of the winding device 3, the ratchet 52, and the loading board 7 to rotate along the first direction, the winding portion 21 of the wire 2 is winded on the sidewall 303 of the winding frame 30. When pulling the winding portion 21 of the wire 2 from the winder 100, the winding portion 21 pulls the winding frame 30 to rotate, the ratchet 52 and the loading board 7 rotate together with the winding frame 30 via the rod 101 along the second direction counter to the first direction. When stopping pulling the winding portion 21, the pawl 53 is coupled between the two sloping teeth 521 of the ratchet 52, the ratchet 52 stops rotation, the winding frame 30 and the loading board 7 stop rotation via the rod 10, therefore, the winding portion 21 is fixed at a required length.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A winder for wire comprising:
a case comprising a base;
a winding device positioned on the base for winding the wire or releasing the wire;
a braking device located between the winding device and the base, the braking device comprising a ratchet and a pawl positioned aside the ratchet for coupling the ratchet; and
a loading board positioned on the winding device and configured to be electrically coupled to the wire;
wherein, the winding device, the ratchet and the loading board can rotate together relative to the base; and
wherein when the pawl is coupled to the ratchet, rotation of the winding device drives the ratchet and the loading board to rotate along a first direction, so that the wire is released from the winding device, and when the pawl is detached from the ratchet, the winding device rotates along a second direction counter to the first direction and drives the ratchet and the loading board to rotate along the second direction, so that the wire is wound onto the winding device.

2. The winder of claim 1, wherein the loading board comprises a plurality of electrode collars electrically insulating to each other.

3. The winder of claim 2, wherein the plurality of electrode collars are concentric.

4. The winder of claim 2, wherein the loading board is a printed circuit board.

5. The winder of claim 1, wherein the winding device comprises a winding frame for winding the wire thereon and a coiling spring coupled to the winding frame for providing elastic restoring force to the winding frame.

6. The winder of claim 5, wherein the coiling spring is received in the winding frame.

7. The winder of claim 6, wherein the base has a rod extending therefrom, the winding frame, the coil spring, the ratchet and the loading board being coupled to the rod.

8. The winder of claim 1 further comprising a fixing device fixed to the base and configured to fix a portion of the wire.

9. The winder of claim 8, wherein the fixing device comprises a plurality of brackets.

10. An electronic device comprising:
a wire comprising a fixing portion and a winding portion spaced from the fixing portion, the wire having a plurality of signal lines extending through the fixing portion and the winding portion; and
a winder configured to wind or release the winding portion of the wire, the winder comprising:
a loading board comprising a plurality of electrode collars electrically insulating to each other;
a winding device coupled to the loading board for winding the wire or releasing the wire; and
a braking device coupled the winding device, the braking device comprising a ratchet and a pawl positioned aside the ratchet for coupling the ratchet;
wherein, the signal lines of the fixing portion are electrically coupled the electrode collars respectively, the winding portion has a first end attached to the winding device, the signal lines of the first end of the winding portion are electrically coupled the electrode collars respectively, the signal lines of the fixing portion and the winding portion form complete signal channels via the electrode collars; and
wherein, the winding device, the ratchet and the loading board can rotate together, when the pawl is coupled to the ratchet, rotation of the winding device drives the ratchet and the loading board to rotate along a first direction and releases the winding portion of the wire from the winding device, when the pawl is detached from the ratchet, the winding device rotates along a second direction counter to the first direction, drives the ratchet and the loading board to rotate along the second direction, and winds the winding portion of the wire to the winding device.

11. The electronic device of claim 10, wherein the winder further comprises base positioning the loading board, the winding device and the braking device thereon, the winding device, the ratchet and the loading board is rotatable together relative to the base.

12. The electronic device of claim 11, wherein the winder further comprises a fixing device fixed to the base, the signal lines of the fixing portion of the wire being coupled to the fixing device.

13. The electronic device of claim 12, wherein the signal lines of the fixing portion each have a contacting pad electrically contact a corresponding electrode collar.

14. The electronic device of claim 13, wherein the fixing device comprises a plurality of brackets, the signal lines of the fixing portion of the wire being coupled to at least one of the brackets.

15. The electronic device of claim 12, wherein the winder further comprises a cover supported by the base, the base and the cover cooperatively defining a case receiving the winding device, the ratchet and the loading board therein.

16. The electronic device of claim 15, wherein the case defines a first window and a second window, the winding portion having a second end exposed out of the case via the first window, the fixing portion extending through the second window and having a first end located in the case and a second end exposed out of the case.

17. The electronic device of claim 11, wherein the winding device comprises a winding frame for winding the winding portion of the wire thereon and a coiling spring coupled to the winding frame for providing elastic restoring force to the winding frame.

18. The electronic device of claim 17, wherein the coiling spring is received in the winding frame.

19. The electronic device of claim 18, wherein the base has a rod extending therefrom, the winding frame, the coil spring, the ratchet and the loading board being coupled to the rod.
